(19) United States
(12) Patent Application Publication
(10) Pub. No.: US 2026/0040301 A1
(43) Pub. Date: Feb. 5, 2026

(54) UL COVERAGE ENHANCEMENT IN NON-TERRESTRIAL NETWORKS

(71) Applicant: InterDigital Patent Holdings, Inc., Wilmington, DE (US)

(72) Inventors: Dylan Watts, Montreal (CA); Moon-il Lee, Melville, NY (US); Brian Martin, Farnham (GB); Umer Salim, Vallauris (FR)

(73) Assignee: InterDigital Patent Holdings, Inc., Wilmington, DE (US)

(21) Appl. No.: 18/794,635

(22) Filed: Aug. 5, 2024

(51) Int. Cl. H04W 72/1268; H04W 68/02; H04W 72/231; H04W 72/51

(52) U.S. Cl. CPC H04W 72/1268; H04W 68/02; H04W 72/231; H04W 72/51

(57) ABSTRACT

A device (e.g., a wireless transmit/receive unit (WTRU)) may support an uplink notification channel. The device may receive a release message to operate in at least one of the idle or the inactive mode. The device may, while operating in the at least one of an idle or an inactive mode, monitor a paging channel for a physical downlink control channel (PDCCH). In response to a PDCCH detection failure on the paging channel, the device may determine to switch to an uplink notification channel. The device may identify uplink notification channel configuration information, and may transmit on the uplink notification channel based on the uplink notification channel configuration information. The device may send an indication on the uplink notification channel to indicate that the WTRU is no longer reachable on a paging channel and is switching to monitor on a downlink notification channel.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems, methods, and instrumentalities are described herein related to an uplink (UL) coverage enhancement in non-terrestrial networks. A wireless transmit/receive unit (WTRU) may indicate its capability to support a UL notification channel prior to release from a radio resource control (RRC) connected mode. The WTRU may receive a configuration for a UL notification channel. The configuration may include, for example, one or more of the following: resources/occasions to transmit, coverage enhancements, configurations for switching to a UL notification channel, and/or configurations for sending a transmission on the UL notification channel. The WTRU may request a configuration for a UL notification channel, for example, upon X failed random access channel (RACH) attempts or upon detection that downlink (DL) coverage may be deteriorating.

The WTRU may switch to a UL notification channel. For example, a WTRU may receive information regarding the support and/or availability of resources that may be dedicated for a UL notification channel for a (e.g., particular) cell, satellite, set of cell(s), set of satellite(s), tracking area, or radio access network (RAN) notification area. The WTRU may be provided with one or more conditions to switch to a UL notification channel or to use resources dedicated for a UL notification channel. The conditions to switch may include, for example, one or more of the following: WTRU does not detect an RS, the WTRU has failed X UL (re) transmissions, and/or the WTRU has exceeded power ramping. The WTRU may apply the UL notification channel configuration and/or use resources that may be dedicated to the UL notification channel, for example, indefinitely, for a time period, while one or more criteria are satisfied, and/or periodically. The WTRU may (e.g., if configured to do so) notify the network, for example, upon transition to the UL notification channel (e.g., using the UL notification channel).

The WTRU may transmit an indication via the UL notification channel. For example, a WTRU may use the UL notification channel configuration or resources dedicated for the UL notification channel to transmit a coverage failure indication (e.g., to indicate issues with UL/DL coverage). A coverage failure indication may include, for example, a one-bit indication (e.g., a flag) that the WTRU may be experiencing coverage issues. The WTRU may provide additional assistance information (e.g., which channel the WTRU is monitoring for a DL response, that the WTRU has not received a response to an earlier message). If the WTRU transmits a message on a UL notification channel, the WTRU may monitor for a response on a DL notification channel, or paging channel (e.g., based on configuration).

An example device may include a processor configured to perform one or more actions (e.g., to accomplish a method/procedure). For example, a device (e.g., a WTRU) may (e.g., be configured to) determine to switch to an uplink notification channel. The device may identify uplink notification channel configuration information. The device may access the uplink notification channel based on the uplink notification channel configuration information. The device may send an indication on the uplink notification channel configured to indicate that the WTRU is monitoring on a downlink notification channel.

For example, the WTRU may determine to switch to an uplink notification channel based on a serving cell condition. The WTRU may identify uplink notification channel configuration information that comprises an indication of a set of resources associated with the uplink notification channel, a set of uplink coverage enhancements associated with the uplink notification channel, and an identifier associated with the WTRU. The WTRU may send an indication on the uplink notification channel, based on the uplink notification channel configuration information, the indication being configured to indicate that the WTRU is no longer reachable on a paging channel.

In examples, the device may receive an indication to operate in at least one of the idle or the inactive mode. The device may, while operating in the at least one of an idle or an inactive mode, monitor a paging channel for a physical downlink control channel (PDCCH). The switching to the uplink notification channel may be determined in response to a PDCCH detection failure on the paging channel.

In examples, the device may receive the uplink notification channel configuration information. In examples, the device may send an uplink notification channel capability indication configured to indicate the WTRU's capability to support uplink notification channel communication. The device, in response to the uplink notification channel capability indication, may receive the uplink notification channel configuration information.

In examples, the device may receive a release message to instructing the WTRU to operate in at least one of an idle or an inactive mode. The device may receive the uplink notification channel information in the release message.

In examples, the uplink notification channel configuration information may comprise at least one of the following: a set of resources associated with the uplink notification channel; a set of uplink coverage enhancements associated with the uplink notification channel; and/or an identifier associated with the WTRU.

In examples, the uplink notification channel configuration information may comprise a set of uplink coverage enhancements associated with an uplink notification. The device may apply the set of uplink coverage enhancements while transmitting on the uplink notification channel. The device may identify an uplink notification channel transmission occasion and may send the indication configured to indicate that the WTRU is no longer reachable on the paging and is switching to monitor on the downlink notification channel during the uplink notification channel transmission occasion.

In examples, the uplink notification channel configuration information may comprise an identifier associated with the WTRU. The indication configured to indicate that the WTRU is monitoring on the downlink notification channel may be sent using the identifier associated with the WTRU.

In examples, the device may determine whether to switch to an uplink notification channel based on at least one of the following: whether an uplink transmission has failed; a number of failed uplink transmissions; a number of failed uplink transmissions within a time period; whether a random access has failed; a number of failed random access attempts; and/or whether the WTRU has exceeded power ramping.

In examples, the switching to an uplink notification channel may be determined based on at least one of the following: a failure to detect paging; a failure to detect a downlink reference signal; a number of detected downlink reference signal being less than a threshold value; a ratio of failed PDCCH vs. successful PDCCH receptions exceeding a threshold value; and/or a failure to identify a suitable cell.

In examples, the device may, e.g., upon sending the indication on the uplink notification channel, monitor the downlink notification channel based on a configured set of occasions associated with the downlink notification channel.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example of integration of a Notification/Alert channel and a “cooperative user” into the paging framework according to an embodiment.

FIG. 3 illustrates an example of transition to and indication via a UL notification channel according to an embodiment.

### EXAMPLE NETWORKS FOR IMPLEMENTATION OF THE EMBODIMENTS

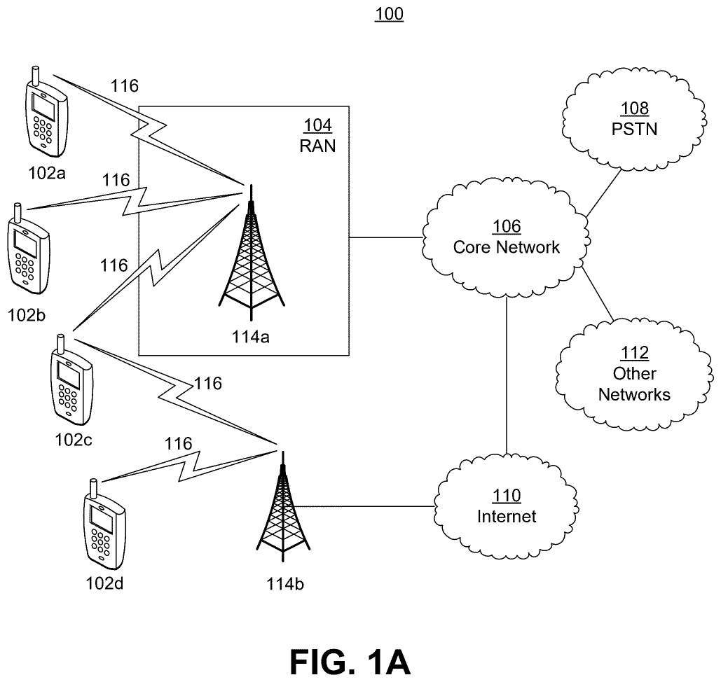

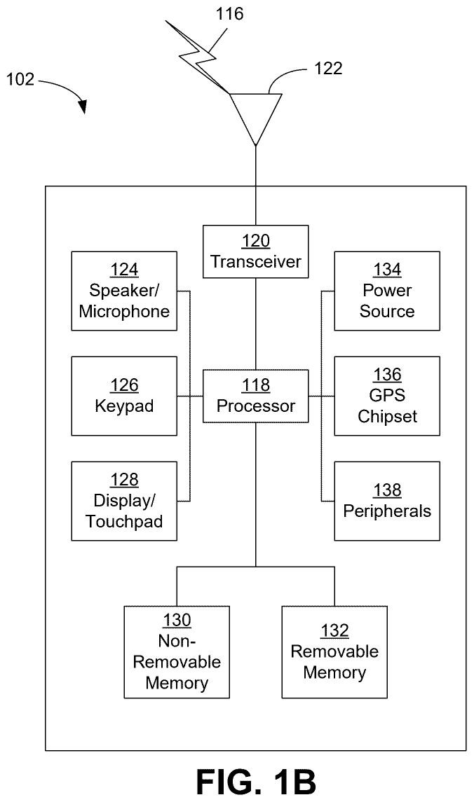

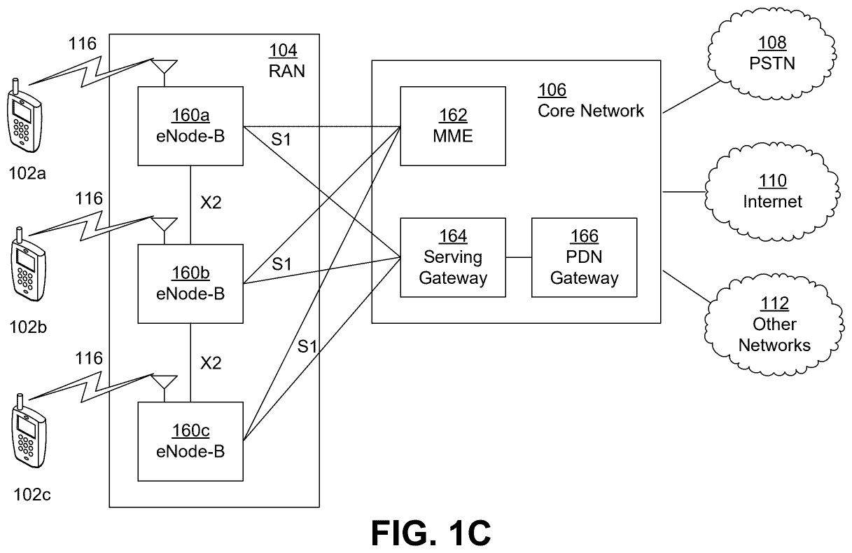

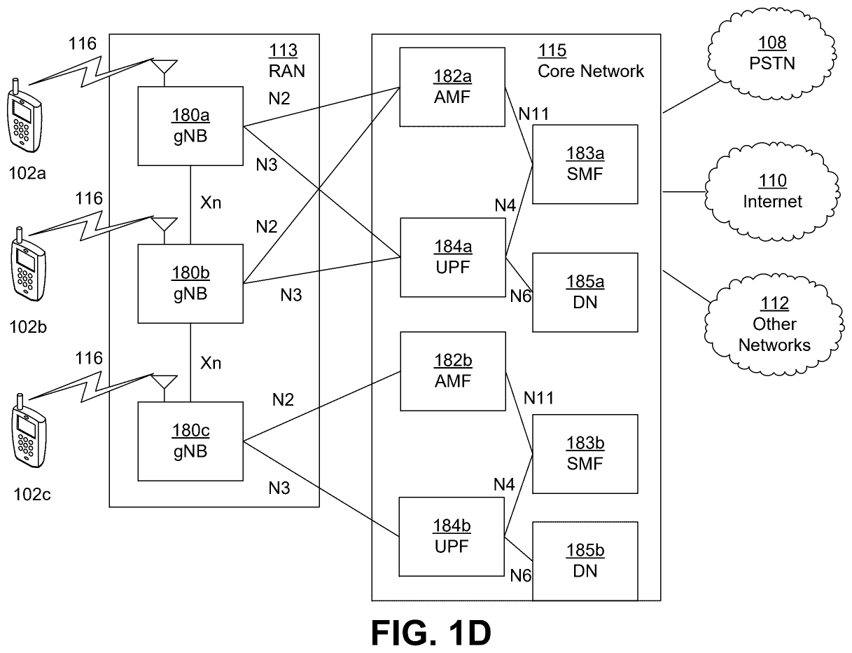

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHz, and/or 160 MHz wide channels. The 40 MHZ, and/or 80 MHZ, channels may be formed by combining contiguous 20 MHZ channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems, methods, and instrumentalities are described herein related to an uplink (UL) coverage enhancement in non-terrestrial networks. A wireless transmit/receive unit (WTRU)) may indicate its capability to support a UL notification channel prior to release from a radio resource control (RRC) connected mode. The WTRU may receive a configuration for a UL notification channel. The configuration may include, for example, one or more of the following: resources/occasions to transmit, coverage enhancements, configurations for switching to a UL notification channel, and/or configurations for sending a transmission on the UL notification channel. The WTRU may request a configuration for a UL notification channel, for example, upon X failed random access channel (RACH) attempts or upon detection that downlink (DL) coverage may be deteriorating.

The WTRU may switch to a UL notification channel. For example, a WTRU may receive information regarding the support and/or availability of resources that may be dedicated for a UL notification channel for a (e.g., particular) cell, satellite, set of cell(s), set of satellite(s), tracking area, or radio access network (RAN) notification area. The WTRU may be provided with one or more conditions to switch to a UL notification channel or to use resources dedicated for a UL notification channel. The conditions to switch may include, for example, one or more of the following: WTRU does not detect an RS, the WTRU has failed X UL (re) transmissions, and/or the WTRU has exceeded power ramping. The WTRU may apply the UL notification channel configuration and/or use resources that may be dedicated to the UL notification channel, for example, indefinitely, for a time period, while one or more criteria are satisfied, and/or periodically. The WTRU may (e.g., if configured to do so) notify the network, for example, upon transition to the UL notification channel (e.g., using the UL notification channel).

The WTRU may transmit an indication via the UL notification channel. For example, a WTRU may use the UL notification channel configuration or resources dedicated for the UL notification channel to transmit a coverage failure indication (e.g., to indicate issues with UL/DL coverage). A coverage failure indication may include, for example, a one-bit indication (e.g., a flag) that the WTRU may be experiencing coverage issues. The WTRU may provide additional assistance information (e.g., which channel the WTRU is monitoring for a DL response, that the WTRU has not received a response to an earlier message). If the WTRU transmits a message on a UL notification channel, the WTRU may monitor for a response on a DL notification channel, or paging channel (e.g., based on configuration).

A Non-Terrestrial Networks (NTN) may include an aerial or space-borne platform which, e.g., via a gateway (GW), may transport signals from a land-based based gNB to a WTRU, and vice-versa. Aerial or space-borne platforms may be classified in terms of orbit. Non-geosynchronous orbit (NGSO) satellites may include low-earth orbit (LEO) satellites, e.g., with an altitude range of 300-1500 km, and medium-earth orbit (MEO) satellites, e.g., with an altitude range 7000-25000 km. NGSO satellites may move continuously overhead relative to Earth. Geosynchronous orbit (GSO) satellites may remain fixed overhead, e.g., by maintaining an altitude at 35,786 km.

Satellite platforms may be (e.g., further) classified as having a “transparent” or “regenerative” payload. Transparent satellite payloads may implement frequency conversion and RF amplification in uplink and downlink. Multiple transparent satellites may be connected to one land-based gNB. Regenerative satellite payloads may implement a full gNB or a gNB DU onboard the satellite. Regenerative payloads may perform digital processing on the signal, e.g., including demodulation, decoding, re-encoding, re-modulation, and/or filtering.

An NTN satellite may support multiple cells. A (e.g., each) cell may include one or more satellite beams. Satellite beams may cover a footprint on Earth (e.g., like a terrestrial cell). Satellite beams may range in diameter, for example, from 100-1000 km in NGSO deployments, and 200-3500 km diameter in GSO deployments. Beam footprints (e.g., the area covered by a beam/cell) in GSO deployments may remain fixed relative to Earth. Beam footprints in NGSO deployments may change over time, e.g., due to satellite movement. Beam movement may be classified as “earth moving,” e.g., where an NGSO beam may move continuously across the earth, or “earth fixed,” e.g., where the beam may be steered to remain covering a fixed location until a new cell overtakes the coverage area in a discrete and coordinated change.

Non-terrestrial networks may be associated one or more of the following operational aspects: 1) continuous movement of NGSO satellites overhead, which may result in frequent and continuous TA drift; 2) cell sizes up to 3500 km in diameter; and 3) round trip times (RTT) several orders of magnitude larger than terrestrial networks (e.g., up to 541.46 ms).

DL coverage may be enhanced in non-terrestrial networks, for example, to accommodate satellite payload constraints. A satellite may be unable to have all its beams active with the (e.g., nominal) equivalent isotropically radiated power (EIRP) density per beam at a given time, e.g., due to limited power and/or limited feeder link bandwidth. The number of beams that can be activated simultaneously may be maximized. An objective may be to maximize the number of user terminals can be served across the satellite foot print while maximizing the overall satellite throughput. An objective may be to ensure that the (e.g., all of the) satellite's radio cells are kept alive, e.g., even without traffic, while allowing new users to join, and preventing impact on end-user QoS. For example, the link level may be managed to improve the link margin of selected physical channels in order to accommodate an EIRP reduction, e.g., in FR1-NTN. A link margin improvement for physical channels (e.g., physical downlink shared channel (PDSCH) and physical downlink control channel (PDCCH)) may be implemented, for example, without impacting the synchronization signal block (SSB) (e.g., apart from extended periodicity). For example, a system level may be managed to support an efficient dynamic and flexible power sharing between beams or different beam pattern/size (e.g., wide or narrow) across the satellite foot print, e.g., for FR1-NTN and FR2-NTN.

UL coverage enhancements may be implemented in non-terrestrial networks.

A DL notification/alert and/or cooperative user detection may be utilized, e.g., for severely DL coverage limited WTRUs. NTN DL coverage may be enhanced to improve line-of-sight (LOS) WTRUs experiencing poor DL coverage due to EIRP density reduction caused by satellite power sharing. Non-line-of-sight (NLOS) WTRUs (e.g., approximately 10% of rural WTRUs) may experience clutter loss, which may result in coverage drops, e.g., of 18 dB. The reduction may severely impact the ability for some NLOS WTRUs to receive DL signaling, such as paging.

In NTN, user actions (e.g., taking a phone outside of a briefcase or moving outdoors) may (e.g., greatly) improve the coverage conditions of a WTRU, which is known as (e.g., may be referred to as) “user cooperation.” A request for user cooperation may be prompted (e.g., indicated, signaled). To prompt such cooperation, a (e.g., simple) notification/alert may be sent to a WTRU, e.g., through a heavily coverage-enhanced channel, which may result in channel conditions being improved sufficiently (e.g., through user actions/cooperation) to receive paging via traditional paging channels. Reaching DL coverage limited WTRUs may be important, for example, to convey emergency signaling and alerts to WTRUs that may not have an alternative form of connection.

Integration of a notification/alert channel for NTN into a (e.g., general) paging framework may be supported/accomplished, for example, based on one or more of the following aspects: a “notification channel” to receive paging in (e.g., very) coverage limited scenarios; and/or a “cooperative user” concept.

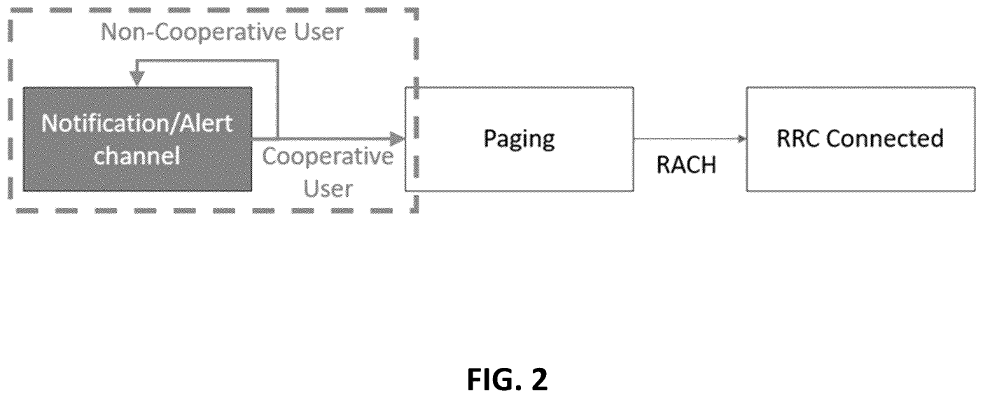

FIG. 2 illustrates an example of integration of a Notification/Alert channel and a “cooperative user” into the paging framework according to an embodiment.

If the DL coverage degrades, such that the WTRU can no longer receive paging, the WTRU may notify the network that it is switching to monitoring the Notification/Alert channel (e.g., via updating the tracking area or RAN-based notification area (RNA)). The Tracking Area update (TAU)/Radio Notification Area Update (RNAU) procedure may involve a signaling exchange to update the network on the current tracking area of the WTRU. Considering the large RTT characteristic of an NTN, an update procedure may take some time to complete. If coverage changes quickly, or if the WTRU detects a degradation in coverage too late, IDLE/INACTIVE WTRUs may become unreachable prior to completion of a TAU/RNAU. The WTRU may utilize a mechanism to notify the network to indicate that the WTRU is unreachable on the current paging channel, e.g., if the mechanism can work in areas of very UL/DL limited coverage.

There may not be a notification channel in legacy. A WTRU may access the network via a legacy RACH procedure. The WTRU may attempt to retransmit the preamble, e.g., up until a configured limitation, prior to declaring RACH failure (e.g., due to poor channel conditions).

The network may be notified that a WTRU can be reached on the DL notification channel, for example, if the UL coverage has also degraded, such that the WTRU may be unable to inform the network via one or more (e.g., traditional) procedures (RACH, TAU).

A WTRU may receive a configuration for a UL notification channel. The configuration may include, for example, one or more of the following: one or more resources/occasions to transmit a UL notification; UL coverage enhancements to apply for notification; and/or a unique identifier for the WTRU. The WTRU may detect that it has lost coverage for a serving cell, and that no other suitable neighboring cells are available. The WTRU may, e.g., at the next UL notification channel occasion and using the coverage enhancements/identifiers within the UL notification channel configuration, indicate that the WTRU is switching from the paging channel to the DL notification channel.

A WTRU may perform one or more of the following actions. The WTRU may receive a UL notification channel configuration. The configuration may include, for example, one or more of the following: a set of occasions/resources to transmit a UL notification channel (e.g., time/frequency occasions, cycles, etc.); a set up UL coverage enhancements to apply to the UL notification (e.g., repetition factor, etc.); and/or an identifier (e.g., a unique identifier) for the WTRU to indicate that the WTRU is changing to the notification channel (e.g., a series of preambles, specific radio network identifiers (RNTIs), etc.). The WTRU may receive a DL notification channel configuration. The configuration may include, for example, one or more of the following: a set of occasions to monitor the notification channel (e.g., same as paging channel, time/frequency occasions, cycles, etc.) and/or characteristics of the notification alert (e.g., whether it is sequence-based or physical downlink control channel (PDCCH)-based) etc. The WTRU may be released to IDLE/INACTIVE (e.g., via the reception of RRCRelease or RRCReleasewithSuspend message). The WTRU may monitor the paging channel. The WTRU may be unable to detect the PDCCH. Other conditions for switching to the UL notification channel may include, for example, one or more of the following: SSB reception, number of SSBs detected within a window, IS/OOS, etc., number of failed PDCCH versus successful PDCCH receptions for the system information block (SIB). The WTRU may measure neighboring cells. The WTRU may be unable to detect any other suitable cell. The WTRU may apply UL coverage enhancements configured within the UL notification channel configuration. The WTRU may wait until the next UL notification channel transmission occasion. The WTRU may transmit (e.g., using the (unique) identifier) an indication on the UL notification channel that the WTRU has lost coverage and may switch to monitoring on the DL notification channel. The WTRU may monitor the DL notification channel (e.g., according to the occasions provided within the notification channel configuration).

As described herein, there may be one or more benefits/advantages. For example, reporting when the WTRU may monitor the notification channel may improve WTRU-NW synchronization and/or may improve (e.g., maximize) the chance that the WTRU may remain reachable at times of poor DL coverage. Signaling overhead may (e.g., also) be reduced, for example, by avoiding repeated RACH failures on the WTRU-side and paging escalation on the network side.

As described herein, a WTRU may provide an indication via a UL notification channel (e.g., similar to a DL notification channel). The indication may provide notice about, for example, one or more of the following: the detection that a UL notification channel may be needed and/or utilized, switching to a UL notification channel, and/or support for transmissions on a UL notification channel.

A WTRU may support one or more (e.g., a combination) of the actions/operations described herein. Terminology, principles/observations, benefits, and examples are described herein.

A “notification/alert channel” may refer to a channel (e.g., meant or configured to be) used in downlink coverage-limited areas where, for example, a WTRU may not be able to receive paging or detect SSB, e.g., via normal operation. The terms “notification channel,” “notification/alert channel,” and “alert channel” may be used interchangeably herein.

A “notification/alert” may refer to a message received (e.g., or alternatively transmitted) by the WTRU over a “notification channel.” For example, a “notification/alert” may be used to notify the user that coverage under current conditions is too poor to receive/transmit data over legacy channels, and/or to prompt the user to improve channel conditions e.g., via user action. The terms “notification,” “notification/alert,” and “alert” may be used interchangeably herein.

A “cooperative user” may be a WTRU in a poor coverage condition that has improved coverage conditions sufficiently to resume and/or have a likelihood of successfully performing (e.g., legacy) operations (e.g., paging and/or RACH). Coverage conditions may have improved, for example, due to user actions (e.g., taking a phone out of a bag), e.g., in response to reception of a notification/alert.

A “non-cooperative user” may be a WTRU in a poor coverage condition that has not improved coverage conditions sufficiently to resume and/or have a likelihood of successfully performing (e.g., legacy) operations (e.g., paging and/or RACH).

Examples described herein highlight a use case of a non-terrestrial network. However, examples described herein may (e.g., also) apply to other networks (e.g., terrestrial, aerial, etc.).

A notification channel may refer to any type of channel (e.g., new or existing, PDCCH-based or sequence based, repetition-based, etc.) that may be used to support coverage limited WTRUs.

A notification/alert channel may be downlink only, support both uplink and downlink, or may have different channels to support uplink and downlink.

A “notification/alert” may refer to a specific message, or (e.g., more generally) to any message received by the WTRU over a “notification/alert channel.”

A “notification” may (e.g., also) be received over a legacy channel. A “notification” may be distinguished from other (e.g., legacy) messages.

Terms such as “channel quality” or “cell quality” may (e.g., be intended to) describe a metric that may be used to evaluate the strength of the radio quality of a WTRU connection. Quality metrics may be based on L1 measurements (e.g., SSB/CSI-RS), filtered L3 measurements (e.g., RSRP/RSRQ), and/or any other measurement or cell quality metric.

Support of a notification/alert channel may improve WTRU operation, e.g., within heavily coverage limited scenarios. Examples described herein may offer, for example, one or more the following benefits: improved WTRU-NW synchronization, which may maximize the chance that the WTRU may remain reachable at times of poor coverage; reduced WTRU signaling overhead, e.g., due to excessive repeated RACH failure; reduced network signaling overhead, e.g., due to a lowered probability of paging escalation; and/or increased WTRU power saving, e.g., by avoiding unnecessary monitoring of a paging channel that signaling cannot or may be unlikely to successfully be received.

A WTRU may provide or be provided with information and/or configurations to support a UL notification channel in a non-terrestrial network. Configurations for a UL notification channel may be specific to a serving cell and/or satellite or (e.g., alternatively) may be provided for multiple cells/satellites, such as a serving cell/satellite and/or one or more neighboring cells/satellites. Configuration(s) or one or more components of a UL notification channel may be common to multiple (e.g., many) WTRUs (e.g., provided via broadcast signaling), dedicated, or group specific. Configuration(s) or one or more components of a configuration for UL notification channel may apply currently or may apply at a time or time period in the future. Information (e.g., as described herein) may be indicated explicitly (e.g., via system information (SI)), provided via one or more configuration(s) (e.g., a “UL notification channel configuration”) and/or may be interpreted implicitly (e.g., via other information, such as satellite assistance information that may be included within ntnConfig).

Examples described herein may support the exchange of (e.g., required/relevant) information between the WTRU and network to support a UL notification channel, which may ensure that information may be acquired/available if/when needed and/or may remain up to date.

A WTRU may provide a capability indication for a UL notification channel. In some examples, a WTRU may indicate its capability to support a UL notification channel. The WTRU may provide its capability for a UL notification channel, for example, in response to a NW request, upon satisfaction of a condition, and/or based on one or more WTRU actions. The contents of the capability indication for a UL notification channel may include one or more sub-capabilities.

A WTRU may provide capability information in response to triggering and/or signaling for the capability indication of the UL notification channel. In some examples, a WTRU may notify the network of the WTRU capability to use and/or perform a transmission on the UL notification channel. The WTRU may provide the capability information, for example, based on (e.g., upon the occurrence of) one or more of the following: (e.g., during) a WTRU capability transfer (e.g., upon RRC connection setup); reception of a request from the network; (e.g., prior to) release from a connected state (e.g., upon or prior to reception of an RRC Release or Release with suspend message); a tracking area update; a ran notification area update; transition to a DL notification channel; reception of paging; and/or initiation of RACH.

A WTRU may signal a capability for the UL notification channel, for example, via RRC signaling (e.g., during the capability transfer message or via WTRU assistance information). In some examples, the WTRU may signal one or more aspects of a UL notification channel capability and/or indicate that one or more capabilities may have changed. The WTRU may signal, for example, via one or more of the following signaling methods: uplink control information (UCI), scheduling request (SR), non-access stratum (NAS), RACH messaging (e.g., MSGA, MSG3, MSG5), PUSCH, medium access control-control element (MAC CE), etc. Capability information may indicate (e.g., general) support for a UL notification channel (e.g., a flag indicating a UL notification channel is supported) and/or may indicate one or more (e.g., specific) capabilities. The signalling method selected by the WTRU may depend on, for example, whether a general indication or detailed information is necessary.

In some examples, a WTRU may (e.g., implicitly) signal that it is capable of signaling on a UL notification channel, for example, via use of one or more dedicated resources (e.g., RNTI, preamble, resources) that may be reserved for a UL notification channel. A capability indication method may be used, for example, if the WTRU was unable to complete the capability indication prior to UL coverage loss.

In some examples, a WTRU may indicate that it is capable of a UL notification channel via a one-bit indication (e.g., a flag). The (e.g., one-bit) indication may imply that the WTRU supports the notification channel and one or more (e.g., some or all) possible configurations related to the UL notification channel (e.g., coverage enhancements, resources periodicities, etc.).

In some examples, a WTRU may indicate one or more (e.g., specific) capabilities related to the UL notification channel. For example, the WTRU may indicate one or more of the following: support for the UL notification channel; and/or support for a subset of resources on the UL notification channel (e.g., a frequency range, frequency bands, and/or time periods).

In some examples, a WTRU may indicate support for one or more aspects of the UL notification channel (e.g., implicitly) via indication of other WTRU capability information. For example, the network may determine (e.g., assume) that if the WTRU indicates support for repetition, the WTRU may also support repetition-based coverage enhancements during UL notification channel transmissions.

The UL notification channel capability information may be (e.g., further distinguished as being), for example, per WTRU, per frequency range (e.g., FR1, or FR2), per band, and/or band combination.

In some examples, a WTRU may be configured for a UL notification channel. Configurations to support a UL notification channel may include, for example, configurations to support the monitoring, switching, and/or transmission for a UL notification channel.

A WTRU may be configured with a configuration for a UL notification channel. In some examples, a WTRU may receive a configuration for a UL notification channel. The configuration for a UL notification channel may include, for example, one or more of the following: a set of occasions/resources to transmit a UL notification channel (e.g., time/frequency occasions, cycles, etc.); and/or a set of UL coverage enhancements that may be applied to the UL notification (e.g., repetition factor, etc.).

A WTRU may be configured with a configuration for switching to a UL notification channel. In some examples, a WTRU may receive a configuration for switching to a UL notification channel. The configuration for switching to a UL notification channel may include, for example, one or more of the following: an indication that the WTRU may (e.g., directly) access the UL notification channel (e.g., without attempting to notify the network); and/or an indication (e.g., flag) that the WTRU may attempt to notify the network prior to switching to the UL notification channel.

A WTRU may be configured with a configuration of UL indication for coverage loss. In some examples, the WTRU may receive a configuration for Indicating the UL coverage loss. The configuration for indicating UL coverage loss may include, for example, one or more of the following: an identifier (e.g., a unique identifier) for the WTRU to indicate that the WTRU is changing to the UL notification channel (e.g., a series of preambles, specific RNTIs, etc.); and/or the channel the WTRU may monitor for a DL response (e.g., the paging channel or the UL notification channel).

In some examples, methods to (re) acquire or release a UL notification channel may be utilized to ensure that the WTRU has (e.g., all required) information to determine if/when the WTRU can transition to a traditional paging channel, and/or to ensure that the information is up to date.

A WTRU may be configured (e.g., by signaling) with a UL notification channel configuration. In some examples, a WTRU may be provided with a UL notification channel configuration upon release to RRC IDLE (e.g., within the RRC Release message) or upon release to RRC INACTIVE state (e.g., within the RRC Release with suspend message). In some examples, configurations for a UL notification channel may be indicated/configured/provided, for example, via one or more of the following signaling methods: SIB (e.g., within satellite assistance information, such as SIB 19, SIB31/32, a (new) SI block, and/or within another existing SIB), NAS, MAC CE, DCI, RACH (e.g., MSG2, MSG4, MSGB), RRC, and/or PDCCH/PUSCH.

In some examples, a WTRU may receive multiple (e.g., different) components of a UL notification channel configuration via multiple (e.g., different) signaling methods. For example, the WTRU may receive one or more (e.g., some) dedicated configuration aspects via RRC signalling (e.g., the UL coverage enhancements to apply), and one or more (e.g., some) other configurations or information via system information (e.g., the resources to transmit on). A WTRU may be provided with a dedicated configuration for a UL notification channel. The WTRU may override other assistance information (e.g., received via broadcast signaling) and/or may combine the (e.g., dedicated) configuration with (e.g., one or more pieces of) the assistance information. In some examples, the WTRU may use the most recently received information.

In some examples, a WTRU may receive a configuration based on a NW decision (e.g., upon release to RRC IDLE or RRC INACTIVE). In some examples, the WTRU may request to be configured with a UL notification channel configuration. The WTRU may request a UL notification channel configuration, for example, based on one or more of the following: if the WTRU detects that the coverage is degrading; based on X failed RACH attempts; and/or based on a lack of detecting a suitable cell.

A WTRU may connect to the cell to receive and/or request a UL notification channel configuration, for example, based on (e.g., upon) detection of one or more of the following: If the WTRU detects that the DL coverage is degrading for the serving cell (e.g., measurements have fallen below a threshold); If the WTRU detects that the DL coverage is degrading for one or more neighboring cell(s) (e.g., measurements have fallen below a threshold); the WTRU cannot find a suitable cell; the WTRU is about to enter a coverage gap; the WTRU updates the tracking area; the WTRU updates the RAN notification area; after a time period

In some examples, the WTRU may (e.g., upon the detection) trigger RACH and request a configuration for a UL channel. The WTRU may request the configuration as part of the RRC Setup/Resume procedure. In some examples, the WTRU may use (e.g., dedicated) messaging to indicate to the network that the WTRU is accessing the cell for acquiring a UL notification channel. For example, the WTRU may provide an (e.g., explicit) indication (e.g., via RACH, MAC CE, UCI), or the WTRU may use, for example, one or more of the following: a dedicated RACH preamble; a dedicated RNTI; dedicated RACH occasions; a resume or establishment cause; and/or dedicated resources (e.g., time period(s), frequency(s)).

A WTRU (e.g., based on a configuration of a UL notification channel) may monitor for one or more trigger conditions to transition to a UL notification channel (e.g., as described herein). The WTRU may release the configuration, for example, based on one or more circumstances, such as an indication by the network that it does not support a UL notification channel.

In some examples, a WTRU may release (e.g., only specific) parts of a configuration.

A WTRU may switch to a UL notification channel. The WTRU may switch to the UL notification channel (e.g., only) under certain conditions (e.g., upon satisfaction of one or more switching criteria), for example, considering that additional resources may be needed (e.g., repetitions, retransmissions) to complete a UL transmission via the UL notification channel, e.g., due to the coverage limited nature. Support for the UL notification channel may depend on network implementation. A UL notification channel may not always be available.

Examples are described herein to support transition of a WTRU to a UL notification channel if/when necessary and available, e.g., including on the resources supported by the network, if/when the coverage conditions of the WTRU indicate a need for a UL notification channel. Examples are described to coordinate application of the UL notification channel between the WTRU and network, e.g., if possible, considering the limited coverage.

A WTRU may switch to a UL notification channel. In some examples, a WTRU may switch to a UL notification channel to attempt to reach the network. The WTRU may switch to the UL notification channel, for example, (e.g., only) if supported by the network and if criteria are satisfied, e.g., to ensure that the WTRU applies the UL notification channel configurations and/or limits use of the UL notification channel resources as needed. Examples are described to support a reattempt, for example, if the WTRU is not able to connect to the UL notification channel, e.g., even though triggered to connect.

Support/availability for a UL notification channel may vary. In some examples, support for a UL channel may depend upon the network implementation/conditions. In some examples, e.g., in heavily loaded cell(s), the network may disable the UL notification channel to free up resources for WTRUs in good coverage. In some examples, e.g., if the network is serving an area with generally poor coverage (e.g., a mountainous or forested area with significant blockage), the network may dedicate substantial resources to the UL notification channel.

The network may indicate characteristics of the UL notification channel (e.g., via RRC, SIB, MAC CE, or DCI), for example, including one or more of the following: an indication (e.g., a flag) that the UL notification channel may be available; an indication (e.g., a flag) that the UL notification channel may not be available; a time when the UL notification channel may become available; a time when the UL notification channel may not be available; and/or a time when the current information regarding the UL notification channel may change.

In some examples, a WTRU may indicate the characteristics of the UL notification channel for a (e.g., particular) cell. In some examples, the characteristics of the notification channel may be valid, for example, for one or more of the following: a beam; a satellite; and/or a tracking area.

A WTRU may indicate the information for (e.g., only) one cell (or beam/satellite etc.) or (e.g., also) for one or more (e.g., neighboring) cells/beams/satellites. The WTRU may include, for example, IDs (e.g., physical cell identity (PCI), cell ID(s), satellite ID(s), beam index(es), tracking area ID(s)) to associate the UL notification channel information with one or more other cell(s)/beam(s)/satellite(s).

In some examples, a network may indicate an (e.g., a specific) area (e.g., geographically) that the UL notification channel applies to. The WTRU may obtain location information (e.g., via GNSS information or network positioning methods) and determine whether the WTRU is within the area. If the WTRU is within the associated area, the WTRU may determine (e.g., assume) that the characteristics of the UL notification channel apply (e.g., are valid). The network may describe the relevant area, for example, via one or more of the following methods: a reference point and distance; one or more reference points (e.g., to describe a polygon); and/or a boundary line and indication of which side the UL notification channel characteristics apply.

In some examples, the network may allow the WTRU to connect to a notification channel (e.g., only) if the WTRU has completed a capability indication prior to transitioning to the UL notification channel. Whether or not a capability indication is needed before an attempt to connect to a notification channel may be configured by the network, or indicated to the WTRU, for example.

One or more triggers may trigger a WTRU to switch to a UL notification channel. In some examples, a WTRU may trigger a switch to a UL notification channel based on conditions related to UL channel quality and/or UL transmissions. For example, the WTRU may switch to a UL notification channel based on one or more of the following: the WTRU failed a UL (re) transmission; the WTRU failed X UL (re) transmissions; the WTRU failed X UL (re) transmissions within a time period; the WTRU failed Random access; the WTRU failed X random access attempts; and/or the WTRU exceeded power ramping.

In some examples, the WTRU may trigger a switch to a UL notification channel based on conditions related to DL channel quality and/or DL reception(s). For example, the WTRU may switch to a UL notification channel based on one or more of the following: WTRU does not detect paging; WTRU does not detect a (e.g., any) DL reference signal (e.g., SSB-RS); WTRU detects fewer than X DI reference signal(s) within a window; The ratio of failed PDCCH versus successful PDCCH receptions exceeds a threshold; and/or WTRU cannot find a suitable cell.

In some examples, the WTRU may trigger a switch to a UL notification channel based on conditions related to the non-terrestrial network deployment scenario and/or environment. For example, the WTRU may switch to a UL notification channel based on one or more of the following: a distance from WTRU to reference point exceeding or falling below a threshold; and/or a distance from the WTRU to a satellite exceeding or falling below a threshold.

In some examples, a WTRU may trigger a switch to a UL notification channel based on one or more WTRU actions. For example, the WTRU may switch to a UL notification channel based on the WTRU switching to monitoring the DL notification channel.

In some examples, the WTRU may switch to the UL notification channel based on (e.g., upon the occurrence of) an indication by the network. The WTRU may receive the indication, for example, via common signaling (e.g., system information, group common DCI) or via dedicated signaling (e.g., paging, RRC configuration).

WTRU behavior may be based on whether the WTRU cannot connect to a UL notification channel. In some examples, a WTRU may not be able to access the UL notification channel, for example, because the UL notification channel may not be currently available and/or the WTRU may not support transmission on the currently supported resources. The WTRU (e.g., in case the WTRU may not immediately access the UL notification channel) may perform one or more of the following actions: perform a cell search/(re) selection and attempt to camp on an alternative suitable cell; not perform UL transmission (e.g., until the UL notification channel becomes enabled); and/or attempt to reach the network via other (e.g., legacy) channels (e.g., trigger RACH).

A WTRU (e.g., if the WTRU cannot access the UL notification channel presently), may apply a backoff time and (e.g., at or after the backup time) reattempt to access the notification channel. The duration of the backoff may be (e.g., explicitly) provided, or may be (e.g., randomly) selected by the WTRU (e.g., by randomly selecting a value within a duration or from a set of value(s)).

A WTRU may apply a UL notification channel configuration. In some examples, the WTRU may apply the UL notification channel configuration, for example, based on (e.g., upon) availability of channel/supported resources from the network and/or satisfaction of (e.g., associated) conditions. The WTRU may apply the UL notification channel configuration, for example, indefinitely or subject to a time period. The WTRU may (e.g., also) notify the network that the WTRU has (e.g., or may) switch to the UL notification channel (e.g., apply the notification channel configuration).

A WTRU may apply a UL notification channel configuration for a duration. In some examples, the WTRU may apply the UL notification channel configuration and/or use UL notification channel resources (e.g., indefinitely) to attempt to reach the network. The WTRU may determine that the WTRU may (e.g., continuously) apply the UL notification channel configuration, for example, based on a (e.g., an explicit) configuration, or by lack of a configuration that limits the application duration.

In some examples (e.g., if the WTRU is provided with one or more UL notification channel resources, such as in the time domain), the WTRU may (e.g., implicitly) determine the time period when the WTRU can apply the UL notification channel configuration (e.g., based on the pattern and time the UL notification resources are available). In some examples (e.g., if the UL notification channel resources are associated with a time period), the WTRU may apply the UL notification channel configuration during a (e.g., the) time period.

In some examples, the WTRU may be configured with a time period to apply the UL notification channel configuration. For example, the WTRU may be provided with a start time and end time (e.g., indicating a time period). The WTRU may apply the UL notification channel configuration and/or transmit on resources reserved for the UL notification channel during the time period indicated by the start and end times. In some examples, the WTRU may be provided with a start time and duration. The WTRU may apply the UL notification channel configuration and/or use resources reserved for the UL notification channel at the indicated time and for the indicated duration. In some examples, the WTRU may be provided with a duration. The WTRU may start the duration (e.g., a time period), for example, upon triggering a switch to the UL notification channel. In some examples, the time period may be maintained in the WTRU via a “UL notification channel timer.” The WTRU may start the timer, for example, upon triggering a switch to the UL notification channel. The WTRU (e.g., while the timer is running) may apply the UL notification channel configuration and/or transmit on the resource(s) reserved for the UL notification channel.

In some examples, the WTRU may apply a UL notification channel configuration periodically. For example, the WTRU may be provided with one or more of the following: a reference time, offset, on duration, and/or periodicity. The WTRU may apply the UL notification channel configuration, for example, after an offset from a reference time (e.g., UTC time, SFN, slot). The WTRU (e.g., during the on duration) may use the resources dedicated for the UL notification channel. The WTRU may apply a UL notification channel configuration and/or use resources dedicated for the UL notification channel again (e.g., for successive on durations), for example, based on the configured periodicity.

The WTRU may start evaluating immediately (e.g., once the procedure is triggered) or after an offset from when the procedure was triggered.

A WTRU may provide a notification of transition to a UL notification channel. In some examples, the WTRU may notify the network that the WTRU is transitioning to the UL notification channel (e.g., indicating the WTRU is applying the UL notification channel configuration and may use resources dedicated for UL notification channel). In some examples, the WTRU may be configured to (e.g., first) attempt a transition notification via one or more (e.g., legacy) procedures (e.g., via RACH, MAC CE, RRC, PUSCH, PUCCH). The WTRU (e.g., if the WTRU fails the UL transmission, such as if the WTRU does not receive a random access response (RAR) or an ACK from the NW) may re-attempt to transmit on the UL notification channel resources, e.g., based on the UL notification channel configuration.

In some examples, whether the WTRU (e.g., first) attempts to notify the network (e.g., via a legacy channel or the UL notification channel) may be based on NW configuration (e.g., within the UL notification channel configuration).

An indication may be provided via a UL notification channel. A Tracking Area update (TAU)/Radio Notification Area Update (RNAU) procedure may involve a signaling exchange to update the network on the current tracking area of the WTRU. Considering the large RTT characteristic of an NTN, an area update procedure may take some time to complete. If DL coverage changes quickly, or the WTRU detects a degradation in coverage too late, IDLE/INACTIVE WTRUs may become unreachable prior to completion of the TAU/RNAU. A WTRU may utilize a mechanism (e.g., that can work in areas of very limited coverage) to notify the network that the WTRU may be unreachable on the current paging channel.

A WTRU experiencing DL coverage issues may (e.g., very likely) also be experiencing UL coverage issues, e.g., considering that NTN scenarios are very likely line of sight (LOS). In some examples, the WTRU may use the UL notification channel and UL notification channel resources to inform the network that DL coverage has degraded, e.g., and that the WTRU may be switching to a DL notification channel.

Examples described herein may support use of the UL notification channel and UL notification channel resources to inform the network of DL/UL coverage issues, e.g., and to inform where/when the WTRU may be reachable (e.g., the paging channel and/or the DL notification channel). The mechanisms may be important to ensure that communication can continue between the WTRU and network, e.g., and to ensure than the WTRU and network may be aligned on when and where the WTRU may be reachable.

A WTRU may transmit a coverage failure indication. In some examples, a WTRU may transmit a coverage failure indication to notify the network, for example, that the WTRU may be experiencing UL and/or DL coverage issues. The WTRU may use (e.g., if available and conditions for use are satisfied) the UL notification channel and/or UL notification channel resources to transmit the coverage failure indication.

A coverage failure indication message may include information (e.g., indication(s) in the contents of the message. In some examples, the coverage failure indication may include an indication (e.g., a flag) that UL and/or DL coverage has degraded (e.g., that the WTRU can no longer transmit or receive on (legacy) channels, such as paging or RACH). In some examples, the coverage failure indication may include additional information (e.g., regarding the start of coverage or reachability of the WTRU). For example, the coverage failure indication may include one or more of the following: an indication (e.g., a flag) that the WTRU is monitoring the DL notification channel; an indication (e.g., a flag) that the WTRU is applying the UL notification channel configuration; an indication (e.g., a flag) that the WTRU is using resources dedicated for UL notification channel; an indication (e.g., a flag) that the WTRU can be reached on the paging channel; and/or a request for a NW response to the coverage failure indication.

A WTRU may transmit a coverage failure indication message based on one or more triggers. In some examples, a WTRU may trigger transmission of a coverage failure notification based on one or more of the following: the WTRU has switched to the DL notification channel; the WTRU has switched to the UL notification channel; one or more conditions to switch to the UL notification channel have been satisfied (e.g., as described herein); reception of DL paging; reception of a DL notification; the WTRU has not received a response to an earlier coverage failure indication; and/or upon completion of a time period (e.g., a backoff or prohibit timer).

A WTRU may transmit a coverage failure indication message. In some examples, a WTRU may transmit a coverage failure indication using one or more resources dedicated for the UL notification channel, as may be most recently indicated (e.g., provided within system information or the UL notification channel configuration). The WTRU may select, for example, the earliest available occasion with the configured coverage enhancements.

A WTRU may signal that one or more aspects of a coverage failure indication have changed, for example, via one or more of the following signaling methods: sequence, UCI, SR, NAS, RACH messaging (e.g., MSGA, MSG3, MSG5), PUSCH, and/or MAC CE. A WTRU may apply UL coverage enhancements prior to transmission. In some examples, the coverage failure indication information may be signaled (e.g., explicitly) within the coverage failure indication message. In some examples, one or more (e.g., each) of the messages (e.g., as described herein) may be associated with an index in a table. The WTRU may indicate one or more index values corresponding to the desired information. In some examples, information or messages (e.g., each piece of information or message) may be associated with a (e.g., dedicated) sequence or RNTI. The WTRU may transmit one or more sequences or one or more RNTIs associated with the information.

A WTRU may receive a response to a coverage failure indication. In some examples, a WTRU may expect a DL response from the network based on (e.g., upon) an indication of coverage failure. The WTRU may determine, for example, which DL channel to monitor for a response (e.g., paging channel or notification channel) or for how long to monitor for a response.

A WTRU may monitor for an NW response to a UL notification message. In some examples, a WTRU may expect and/or may monitor for a DL response (e.g., after sending a coverage failure indication). The WTRU may monitor for the DL response, for example, on the paging channel or the DL notification channel. The channel the WTRU selects to monitor may be based on, for example, one or more of the following configurations, indications, and/or criteria: WTRU defaults to monitoring for a response on the notification alert channel; WTRU defaults to monitoring for a response on the paging channel; WTRU monitors whichever channel has been configured; and/or WTRU monitors whichever channel the WTRU indicated it would monitor in the coverage failure indication message.

In some examples, the WTRU may monitor a (e.g., one) channel for a time period and then switch to monitoring another channel. For example (e.g., upon transmission of the coverage failure indication), the WTRU may monitor for a DL response on the paging channel and start a timer. The WTRU may switch to monitoring the DL notification channel, for example, if the WTRU does not receive a DL response by the timer expiry. In some examples, the WTRU may wait up to X occasions for a DL response. The WTRU may, for example, if a response is not received after X occasions the WTRU may switch to monitoring another channel.

A NW may signal a response to a WTRU's UL notification message. In some examples, the network may send an ACK response to a WTRU's UL coverage failure indication message. If the WTRU indicated additional information within the coverage failure indication message (e.g., as described herein) the WTRU may determine (e.g., assume), for example, based on receiving the ACK response, that the network understood the additional information in the message, which may allow the WTRU to act accordingly (e.g., the WTRU may send future messages on the DL notification channel).

As described herein, in some examples, a WTRU may receive a configuration for a DL notification/alert channel (e.g., a set of occasions to monitor channel and an RNTI to decode signaling received via the channel). The WTRU may (e.g., also) receive a configuration for a UL notification/alert channel (e.g., resources/occasions to transmit a UL notification, a set of coverage enhancements to apply, and a dedicated WTRU identifier). The WTRU (e.g., upon release to RRC_IDLE/INACTIVE) may monitor the paging channel, for example, according to a (e.g., legacy) procedure.

The WTRU may apply the UL notification channel configuration, for example, if the WTRU detects that the WTRU lost coverage for the serving cell, and determines that there are no other suitable (e.g., neighboring) cells available. The WTRU may indicate that it is switching from the paging channel to the DL notification channel. The WTRU may provide the notification at the next available UL notification channel occasion (e.g., indicated within system information for the particular camped cell). The WTRU may provide the notification using the coverage enhancements/identifiers within the UL notification channel configuration.

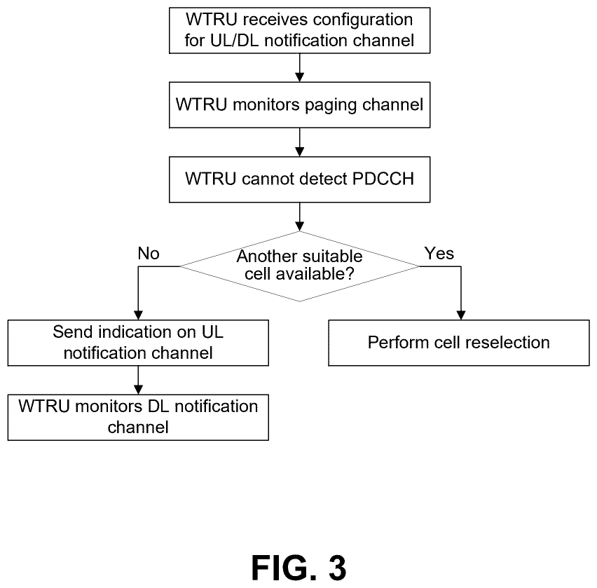

FIG. 3 illustrates an example of transition to and indication via a UL notification channel according to an embodiment.

A WTRU may perform one or more of the following (e.g., to support coverage failure indication via a UL notification channel). For example, a WTRU may receive a UL notification channel configuration. The configuration may include, for example, one or more of the following: a set of occasions/resources to transmit a UL notification channel (e.g., time/frequency occasions, cycles, etc.); a set of UL coverage enhancements to apply to the UL notification (e.g., repetition factor, number of retransmissions, an increased transmission power, a different MCS value); and/or an (e.g., a unique) identifier for the WTRU to indicate that the WTRU may change to the notification channel (e.g., a series of preambles, specific RNTIs, etc.). The WTRU may receive a DL notification channel configuration. The configuration may include, for example, one or more of the following: a set of occasions to monitor the notification channel (e.g., same as paging channel, time/frequency occasions, cycles, etc.); and/or characteristics of the notification alert (e.g., whether it is sequence-based or PDCCH-based, etc.). The WTRU may be released to IDLE/INACTIVE (e.g., via the reception of RRCRelease or RRCReleasewithSuspend message). The WTRU may monitor the paging channel. The WTRU may be unable to detect PDCCH. Other conditions for switching to the UL notification channel may include, for example, one or more of the following: SSB reception, number of SSBs detected within a window, IS/OOS, number of failed PDCCH versus successful PDCCH receptions for SIB, etc. The WTRU may measure neighboring cells. The WTRU may be unable to detect a (e.g., any other) suitable cell. The WTRU may apply UL coverage enhancements configured within UL notification channel configuration. The WTRU may wait until the next UL notification channel transmission occasion. The WTRU may transmit (e.g., using the (unique) identifier) an indication on the UL notification channel that the WTRU lost coverage and/or that the WTRU may switch to monitoring on the DL notification channel. The WTRU may monitor the DL notification channel.

A WTRU may receive a configuration for a UL notification channel. The configuration may include, for example, one or more of the following: resources/occasions to transmit a UL notification; one or more UL coverage enhancements to apply for the UL notification; and/or an (e.g., a unique) identifier for the WTRU. The WTRU may detect that the WTRU lost coverage for the serving cell and may determine that there are not any other suitable neighboring cells available. The WTRU (e.g., at the next UL notification channel occasion and using the coverage enhancements/identifiers within the UL notification channel configuration) may indicate that the WTRU is switching from the paging channel to the DL notification channel.

There may be one or more benefits/advantages. Reporting when a WTRU may monitor the notification channel may improve WTRU-NW synchronization and/or may improve (e.g., maximize) the chance the WTRU may remain reachable at times of poor DL coverage. Reporting when a WTRU may monitor the notification channel may (e.g., also) reduce signaling overhead, for example, by avoiding repeated RACH failures on the WTRU-side and/or paging escalation on the network side.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1. A wireless transmit/receive unit (WTRU) comprising:
a processor configured to:
determine to switch to an uplink notification channel based on a serving cell condition;
identify uplink notification channel configuration information that comprises an indication of a set of resources associated with the uplink notification channel, a set of uplink coverage enhancements associated with the uplink notification channel, and an identifier associated with the WTRU; and
send an indication on the uplink notification channel, based on the uplink notification channel configuration information, the indication being configured to indicate that the WTRU is no longer reachable on a paging channel.

2. The WTRU of claim 1, wherein the processor is further configured to:
receive an indication to operate in at least one of the idle or the inactive mode; and
while operating in the at least one of an idle or an inactive mode, monitor the paging channel for a physical downlink control channel (PDCCH), wherein switching to the uplink notification channel is determined in response to a PDCCH detection failure on the paging channel.

3. The anchor WTRU of claim 1, wherein the processor is further configured to:
receive the uplink notification channel configuration information.

4. The WTRU of claim 1, wherein the processor is further configured to:
send an uplink notification channel capability indication configured to indicate the WTRU's capability to support uplink notification channel communication; and
in response to the uplink notification channel capability indication, receive the uplink notification channel configuration information.

5. The WTRU of claim 1, wherein the processor is further configured to:
send an uplink notification channel capability indication configured to indicate the WTRU's capability to support uplink notification channel communication; and
in response to the uplink notification channel capability indication, receive downlink notification channel configuration information, wherein the downlink notification channel configuration information is configured to indicate a set of occasions associated with monitoring a downlink notification channel and at least notification alert characteristic.

6. The WTRU of claim 1, wherein the processor is further configured to:
receive a release message to operate in at least one of an idle or an inactive mode, wherein the uplink notification channel configuration information is received in the release message.

7. The WTRU of claim 1, wherein the processor is further configured to:
apply the set of uplink coverage enhancements while transmitting on the uplink notification channel; and
identify an uplink notification channel transmission occasion, wherein the indication configured to indicate that the WTRU is no longer reachable on the paging channel is sent during the uplink notification channel transmission occasion.

8. The WTRU of claim 1, wherein the indication configured to indicate that the WTRU is no longer reachable on the paging channel is sent using the identifier associated with the WTRU.

9. The WTRU of claim 1, wherein the processor is further configured to:
determine whether to switch to an uplink notification channel based on at least one of:
whether an uplink transmission has failed;
a number of failed uplink transmissions;
a number of failed uplink transmissions within a time period;
whether a random access has failed;
a number of failed random access attempts; or
whether the WTRU has exceeded power ramping.

10. The WTRU of claim 1, wherein the switching to an uplink notification channel is determined based on at least one of:
a failure to detect paging;
a failure to detect a downlink reference signal;
a number of detected downlink reference signal being less than a threshold value;
a ratio of failed PDCCH vs. successful PDCCH receptions exceeding a threshold value; or
a failure to identify a suitable cell.

11. The WTRU of claim 1, wherein the processor is further configured to:
upon sending the indication on the uplink notification channel, monitor a downlink notification channel based on a configured set of occasions associated with the downlink notification channel.

12. A method performed by a wireless transmit/receive unit (WTRU), comprising:
determining to switch to an uplink notification channel based on a serving cell condition;
identifying uplink notification channel configuration information that comprises an indication of a set of resources associated with the uplink notification channel, a set of uplink coverage enhancements associated with the uplink notification channel, and an identifier associated with the WTRU; and
sending an indication on the uplink notification channel, based on the uplink notification channel configuration information, the indication being configured to indicate that the WTRU is no longer reachable on a paging channel.

13. The method of claim 12, further comprising:
receiving an indication to operate in at least one of the idle or the inactive mode; and
while operating in the at least one of the idle or the inactive mode, monitoring the paging channel for a physical downlink control channel (PDCCH), wherein switching to the uplink notification channel is determined in response to a PDCCH detection failure on the paging channel.

14. The method of claim 12, further comprising:
receiving the uplink notification channel configuration information in a configuration message.

15. The method of claim 12, further comprising:
sending an uplink notification channel capability indication configured to indicate the WTRU's capability to support uplink notification channel communication; and
in response to the uplink notification channel capability indication, receiving the uplink notification channel configuration information.

16. The method of claim 12, further comprising:
applying the set of uplink coverage enhancements while transmitting on the uplink notification channel; and
identifying an uplink notification channel transmission occasion, wherein the indication configured to indicate that the WTRU is no longer reachable on the paging channel is sent during the uplink notification channel transmission occasion.

17. The method of claim 12, further comprising:
receive a downlink notification channel configuration indication that comprise an indication of a set of occasions associated with a downlink notification channel; and
upon sending the indication on the uplink notification channel, monitor the downlink notification channel based on the configured set of occasions associated with the downlink notification channel.

18. The method of claim 12, wherein the indication configured to indicate that the WTRU is no longer reachable on the paging channel is sent using the identifier associated with the WTRU.

19. The method of claim 12, further comprising:
determining whether to switch to an uplink notification channel based on at least one of:
whether an uplink transmission has failed;
a number of failed uplink transmissions;
a number of failed uplink transmissions within a time period;
whether a random access has failed;
a number of failed random access attempts; or
whether the WTRU has exceeded power ramping.

20. The method of claim 12, wherein the switching to an uplink notification channel is determined based on at least one of:
a failure to detect paging;
a failure to detect a downlink reference signal;
a number of detected downlink reference signal being less than a threshold value;
a ratio of failed PDCCH vs. successful PDCCH receptions exceeding a threshold value; or
a failure to identify a suitable cell.
